(19) United States
(12) Patent Application Publication
(10) Pub. No.: US 2019/0073111 A1
(43) Pub. Date: Mar. 7, 2019

(54) METHODS AND SYSTEMS USING A ROTATABLE THREE-DIMENSIONAL OBJECT PROVIDING VISUAL USER INFORMATION ON A DISPLAY

(71) Applicant: Future Mobility Corporation Limited, Hong Kong (HK)

(72) Inventors: Wolfram Luchner, Los Altos Hills, CA (US); Gerhard Kremer, San Jose, CA (US); Ari Romano Pfefferkorn, Cupertino, CA (US)

(21) Appl. No.: 15/695,792

(22) Filed: Sep. 5, 2017

(51) Int. Cl. G06F 3/0481; G06F 3/0488; B60K 37/00; B60W 50/08; H04N 21/482; G07C 5/08

(52) U.S. Cl. CPC G06F 3/04815; G06F 3/0488; B60K 37/00; B60K 2350/1052; H04N 21/482; G07C 5/0825; G06F 2203/04802; B60W 50/08

(57) ABSTRACT

Methods and systems are disclosed using a rotatable three-dimensional object providing visual user information on a display. For one example, a data processing system includes a display, a memory, and a processor. The memory stores one or more types of information related to a user. The processor is coupled to the display and memory, and is configured to generate a rotatable three-dimensional object visually representing one or more types of user information on the display. For one example, the display can be a coast-to-coast display for an electric or non-electric vehicle. The coast-to-coast display can include a plurality of display areas and the rotatable three-dimensional object is displayed in at least one of the display areas. The rotatable three-dimensional object can be a polyhedron including a plurality of faces wherein each type of user information corresponds to a face of the polyhedron. Each face of the polyhedron can correspond to a type of user information and includes a plurality of dots connected by lines defining the face. Each dot of each face that corresponds to a type of user information represents a data point or a parameter of the corresponding type of user information.

### FIELD

Embodiments of the invention are in the field of data processing systems and display interfaces. More particularly, embodiments of the invention relate to methods and systems using a rotatable three-dimensional object providing visual user information on a display.

### BACKGROUND

Control interfaces on display devices typically display numerous objects which can clutter a display for a user of a computing device such as desktop computer, laptop computer, tablet, mobile phone, and etc. Such displayed objects can provide limited user information. For example, objects such as icons (e.g., an activity icon) are provided on a display to identify an application for a user to touch or select. The user can touch the display where the icon is located to launch the application. For existing control interfaces, icons or objects are simply used to launch applications without providing any additional user information.

### SUMMARY

Methods and systems are disclosed using a rotatable three-dimensional object providing visual user information on a display. For one example, a data processing system includes a display, a memory, and a processor. The memory stores one or more types of information related to a user. The processor is coupled to the display and memory, and is configured to generate a rotatable three-dimensional object visually representing one or more types of user information on the display. For one example, the display can be a coast-to-coast display for an electric or non-electric vehicle. The coast-to-coast display can include a plurality of display areas and the rotatable three-dimensional object is displayed in at least one of the display areas.

For one example, the rotatable three-dimensional object can be a polyhedron including a plurality of faces wherein each type of user information corresponds to a face of the polyhedron. Each face of the polyhedron can correspond to a type of user information includes a plurality of dots connected by lines defining the face. Each dot of each face that corresponds to a type of user information represents a data point or a parameter of the corresponding type of user information. For one example, each dot of each face that corresponds to a type of user information can be weighted that distorts the polyhedron. The polyhedron can be randomly distorted based on the weight for each dot. For one example, the processor is configured to distort the polyhedron if data points or parameters are updated or changed for each type of user information.

For one example, the data processing system also includes a hand movement capturing device that is coupled to the processor and captures hand gestures of the user. The processor is configured to rotate the polyhedron on the display based on the captured hand gestures of the user. For one example, the processor is configured to select one of the faces of the polyhedron that corresponds to a type of user information based on the captured hand gestures. For one example, the types of information can include at least entertainment, health, or activity type of user information.

Other methods and systems for using rotatable three-dimensional object providing types of user information are described.

### BRIEF DESCRIPTION OF THE DRAWINGS

The appended drawings illustrate examples and are, therefore, exemplary embodiments and not considered to be limiting in scope.

FIG. 1 illustrates one exemplary environment for using a rotatable three-dimensional object such as a rotating polyhedron providing types of user information on a coast-to-coast display of an automobile dashboard.

FIG. 2 illustrates one example environment for a coast-to-coast display displaying a rotating polyhedron.

FIG. 3 illustrates one example block diagram of data processing system architecture for the exemplary environment of FIGS. 1-2.

FIG. 4 illustrates one example block diagram of a computing system for the data processing system architecture of FIG. 3.

FIG. 5A-5D illustrate examples of generating rotating polyhedrons providing types of user information.

FIG. 6A-6B illustrate exemplary faces of a rotating polyhedron.

FIGS. 7A-7D illustrates examples of different types of three-dimensional objects as rotating polyhedrons.

FIG. 8 illustrates a block diagram of a computing system to render a three-dimensional object on a display.

FIG. 9 illustrates a flow diagram of one example of an operation to display a rotating polyhedron with faces corresponding to types of user information.

FIG. 10 illustrates a flow diagram of one example of an operation to display a rotating polyhedron with weighted dots.

### DETAILED DESCRIPTION

Embodiments and examples are disclosed using a rotatable three-dimensional object providing visual user information on a display.

For one example, a data processing system includes a display, a memory, and a processor. The memory stores one or more types of information related to a user. The processor is coupled to the display and memory, and is configured to generate a rotatable three-dimensional object visually representing one or more types of user information on the display. For one example, the display can be a coast-to-coast display for an electric or non-electric vehicle. The coast-to-coast display can include a plurality of display areas and the rotatable three-dimensional object is displayed in at least one of the display areas.

The rotatable three-dimensional object can be a polyhedron including a plurality of faces wherein each type of user information corresponds to a face of the polyhedron. Each face of the polyhedron can correspond to a type of user information and includes a plurality of dots connected by lines defining the face. Each dot of each face that corresponds to a type of user information represents a data point or a parameter of the corresponding type of user information. By using a rotatable three-dimensional object such as a rotatable polyhedron, the disclosed examples and embodiments provide improvements to display interfaces by minimizing cluttering of a display with objects that can provide more user information using faces, dots and lines of the polyhedron.

As set forth herein, various embodiments, examples and aspects will be described with reference to details discussed below, and the accompanying drawings will illustrate various embodiments and examples. The following description and drawings are illustrative and are not to be construed as limiting. Numerous specific details are described to provide a thorough understanding of various embodiments and examples. However, in certain instances, well-known or conventional details are not described in order to provide a concise discussion of the embodiments and examples. Although the following examples and embodiments are directed to an environment for an automobile, the rotating three-dimensional objects such a rotating polyhedron providing user information by way of polygonal faces, dots, or lines can be used in any display interface environments.

Exemplary Environment Using Rotatable Three-Dimensional Object

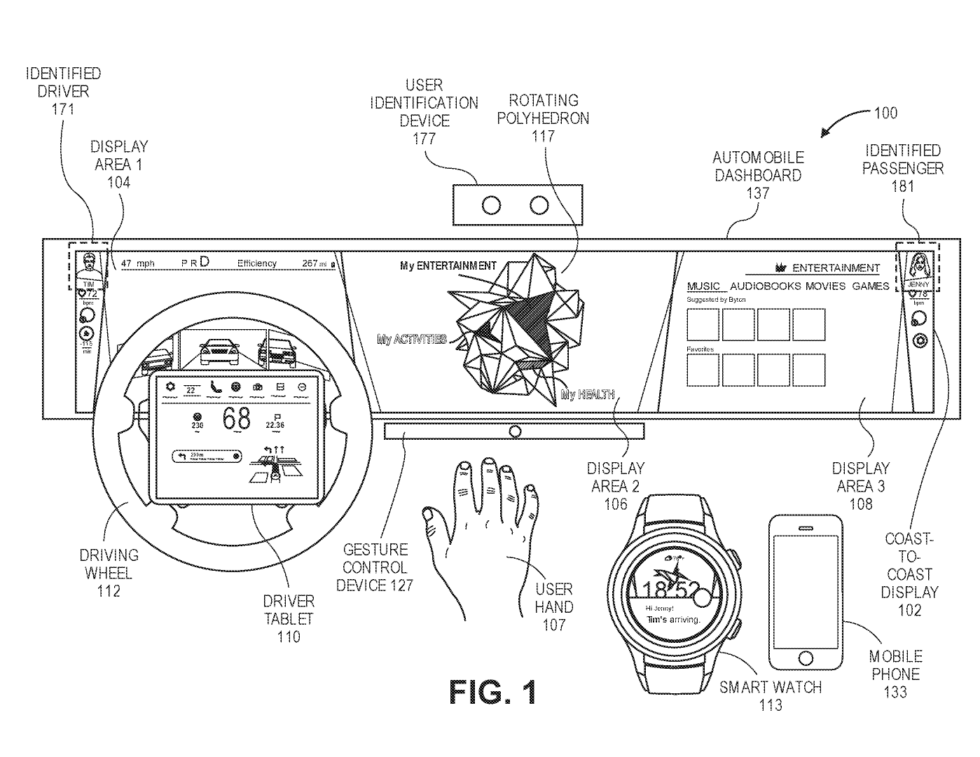

FIG. 1 illustrates on exemplary environment 100 for using a rotatable three-dimensional object such as rotating polyhedron 117 providing types of user information on a coast-to-coast display 102 of an automobile dashboard 137. Environment 100 can represent an interior of an automobile such as an electric or non-electric vehicle or car having a driving wheel 112 with a driver tablet 110 mounted on it, automobile dashboard 137 including coast-to-coast display 102, and gesture control device 127, and user identification device 177. Exemplary environment 100 can also include one or more mobile computing devices such as smart watch 113 and mobile phone 133.

For one example, user identification device 177 is located and positioned above automobile dashboard 137 having one or cameras (e.g., a stereo camera) used to detect and identify a driver (e.g., identified driver 171 “Tim” or identified passenger 181 “Jenny”). Although not shown, environment 100 can include additional cameras located inside or outside of the vehicle or automobile to provide rearview and side view images in place of using rearview and side view mirrors which can be displayed on coast-to-coast display 102. User identification device 177 can be mounted in a location where a rearview mirror would be located in an automobile. For one example, user identification device 177 can capture images of a user (e.g., two-dimensional 2D or three-dimensional 3D images including facial features using 2D or 3D cameras). The captured images can be compared to stored images which have been registered for the automobile in order to recognize and authenticate a user (e.g., a driver or passenger) as a valid user and allow access to the automobile including controls and interfaces on coast-to-coast display 102.

For one example, gesture control device 127 is located and positioned below automobile dashboard 137 having one or more cameras (e.g., a time of flight TOF camera) and motion sensors to detect hand gestures and movement of user hand 107. For example, user hand 107 can represent a hand of a driver or a passenger (e.g., who have been properly recognized as a valid user) and gesture control device 127 can capture user gestures (e.g., gestures of user hand 107) in controlling or accessing functions, applications, information, options, icons, or objects provided on coast-to-coast display 102. For one example, gesture control/user identification device 127 can include hardware and software from Intel Realsense.®

For one example, driver tablet 110 is a tablet computer and can provide a touch screen with haptic feedback and controls. Driver tablet 110 can provide primary vehicle function controls for a driver or user such as climate control and various settings for environment 100. Driver tablet 110 or a computer within dashboard 137 can be coupled to user identification 177 and gesture control device 127 to recognize a driver (e.g., Tim) or a passenger (e.g., Jenny) and allow the driver or passenger to use gesture control device 127 and access coast-to-coast display 102. For one example, driver tablet 110 (or a computer within dashboard 137) can provide any number of representations, objects, icons, or buttons on its touchscreen providing functions, navigation user interface, phone control user interface to answer phone calls via a Bluetooth connection with mobile phone 133 or receive data and information from a wearable device such as smart watch 113, e.g., activity information such as heartbeats or number of steps climbed.

Coast-to-coast display 102 can include a light emitting diode (LED) display, liquid crystal display (LCD), organic light emitting diode (OLED), or quantum dot display, which can run from one side to the other side of automobile dashboard 137. For one example, coast-to-display 102 can be a rectangular or curved display integrated into and spans the width of automobile dashboard 137. Although not shown, dashboard 137 can include one or more automobile computers to implement interfaces and applications for coast-to-coast display 102 and other automobile controls. Coast-to-coast display 102 can provide one or more graphical user interfaces can be provided in a plurality of display areas such as display areas 1 (104), 2 (106), and 3 (108) of coast-to-coast display 102. Such graphical user interfaces can include status menus shown in, e.g., display areas 1 (104) and 3 (108).

For one example, coast-to-coast display 102 includes a plurality of display areas such as display areas 1 (104), 2 (106), and 3 (108). Display area 1 (104) can show rearview or side view images of the vehicle or automobile from one or more cameras which can be located outside or inside of the automobile in order to capture rear view of side view images. For one example, display area 2 (106) provides and displays a rotatable three-dimensional object such as rotating polyhedron 127 having polygonal faces defined by dots and lines. Alternatively, display area 3 (108) can display rotating polyhedron 127. Rotating polyhedron 127 can appear in display area 2 (106) as floating in space and can rotate at a constant or variable speed.

For one example, rotating polyhedron 127 can provide a group of information using one or more faces, dots, and lines which can provide a tangible form of various parameters and types of user information. For example, any number of drivers or users can be identified, recognize, and authenticated as a valid user with user identification device 177 having corresponding user information and applications associated with a valid user. Examples of types or groups of information associated with the driver or user can include user information and application such as “MyEntertainment”, “MyActivities”, and “MyHealth” with a corresponding face on rotating polyhedron 117 as shown in display area 2 (106). The dots or lines and number of dots and lines defining polygonal faces on rotating polyhedron 117 can also represent various parameters related to user information such as “MyEntertainment”, “MyActivities”, and “MyHealth.” For example, the number of dots defining the polygonal face for MyHealth can indicate the number of categories of health information.

For one example, a driver or user hand 107 can rotate polyhedron 127 along any axis using hand gestures captured by gesture control device 127 to select a user information or application by moving a desired face of the polyhedron 127 to the foreground, e.g., the foreground of display area 2 (106). Referring to FIG. 1, the face for MyEntertainment is in the foreground indicating that it is a selected user information or application. For one example, when a selected user information or application is positioned in the foreground, e.g., MyEntertainment, by user hand 107 the user information or application icons, categories, items, controls, etc. are shown in display area 3 (108). For other examples, a control object or cursor or avatar can be shown in coast-to-coast display 102 to select faces on polyhedron 127. Examples of user gestures to rotate the polyhedron include moving the hand or fingers from left to right or vice versa to rotate the polyhedron 127 accordingly. Other movements can be recognized to rotate polyhedron 127 along different axis to move a desired face of polyhedron 117 to the foreground to select the desired user information or application, e.g., MyEntertainment. Once a desired face of polyhedron 127 is in the foreground, a user can provide a grab and release motion with user hand 107 to obtain additional information regarding the selected user information or application.

In order to avoid clutter on coast-to-coast display 102, a limited number of types or categories of user information can be displayed on rotating polyhedron 127 such as MyEntertainment, MyActivities, and MyHealth. That is, in environment 100, showing, e.g., 50 applications on coast-to-coast display 102 is not safe or practical. When in a driving environment, reducing information shown to a driver or user is preferred on automobile dashboard 137. In accessing user information on rotating polyhedron 117, a user hand 107 can control object control 122 to cover a polygonal face of rotating polyhedron 117 corresponding to, e.g., MyEntertainment.

Referring to FIG. 1, for example, the polygonal face for MyEntertainment includes four dots or sides which can correspond to four parameters or categories for the user when accessing MyEntertainment, e.g., “Music,” “Audiobooks,” “Movies,” and “Games” are shown in display area 3 (108). A driver or user can motion with user hand 107 to rotate polyhedron 117 such that the MyEntertainment face is in the foreground to select MyEntertainment and displays specific items for MyEntertainment in display area 3 (208). A driver or user can then motion with user hand 107 to display area 3 (108) captured by gesture control device 127 to access, e.g., a particular music item in display area 3 (108) under Music category to play. Similarly, “MyActivities” and “MyHealth” includes four points and lines which can represent four different parameters or categories of user information, e.g., phone calls, heart beats, number of steps climbed, etc. For other examples, a dot can represent the weight of a user, the heart rate of a user, etc. The number of dots and lines can alter and modify the shape of rotating polyhedron 117. For example, if more dots are health related, the polygonal face for “MyHealth” can have polygonal surface with a larger number of dots and lines with a larger face.

Referring to “MyEntertainment” example, when a user watches a movie a data point can be generated in the “MyEntertainment” face of rotating polyhedron 127. Referring to “MyActivities” example, a data point can be generated for a missed cell phone call. Data points can also be generated indicating unread text messages. For “MyHealth” example, some dots on rotating polyhedron 117 can be preconfigured such as indicating user weight. In other examples, a driver or user by way of driver table 110 can add dots, e.g., dots indicating blood pressure or dots keeping track of steps for health purposes. The added dots can alter the polygonal face for “MyHealth” on rotating polyhedron 117. Each driver or user can have a user account which can generate a minimum number of baseline dots in rendering rotating polyhedron 117 on coast-to-coast display 102. The driver or user can also add dots on specific types of information to tack, e.g., missed calls.

Categories, associated information and parameters can be generated or inputted by a user with driver tablet 110 or downloaded or entered using, e.g., mobile phone 133 or smart watch 113 (or any other mobile computing device) to driver tablet 110 which controls and provides information to coast-to-coast display 102. For one example, a user or driver is authenticated or identified before information and parameters can be generated or inputted for rotating polyhedron 117, which can be stored in one or more memories or databases stored in or coupled with driver tablet 110. For each user or driver, a personalized rotating polyhedron 117 can be provided and associated with respective personal information and parameters, e.g., heartbeats, heart rate, etc. For example, each user of driver can generate data points or can be automatically generated which can alter the shape of rotating polyhedron 117. The examples and embodiments for using rotating polyhedron 117 can be used any display interface environment such as a display interface for desktops, laptops, tablets, netbooks, mobile phones and devices in reducing clutter on a display.

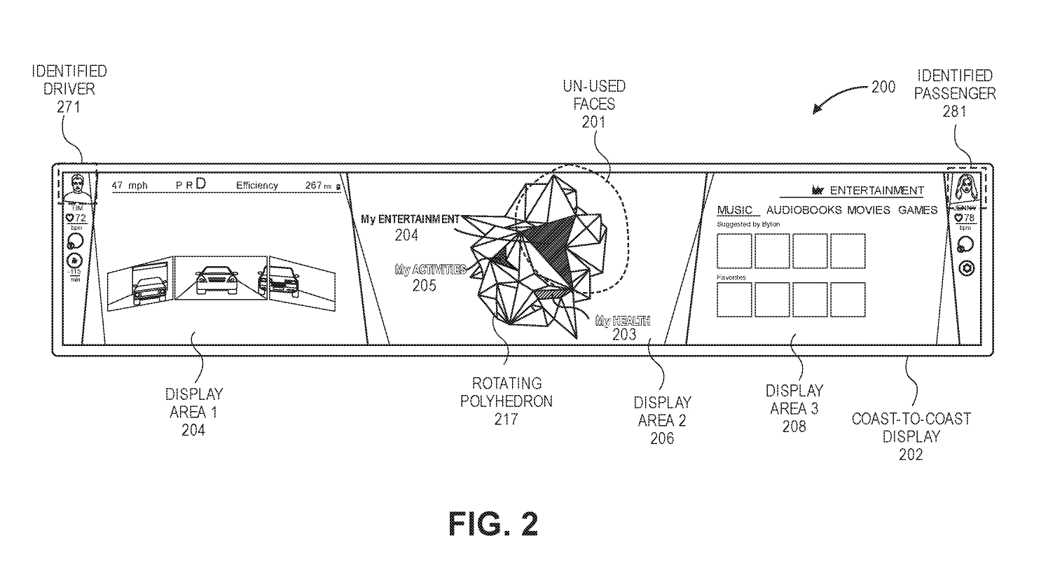

FIG. 2 illustrates one example environment 200 for a coast-to-coast display 202 displaying rotating polyhedron 217. For this example, the driving wheel, user hand, and smart watch are not shown in order to illustrate coast-to-coast display 202 and other features of using rotating three-dimensional object such as a rotating polyhedron 217 which can be used in exemplary environment 100 of FIG. 1.

Referring to FIG. 2, coast-to-coast display 202 includes display areas 1, 2 and 3 (204, 206, 208). Within display area 2 (206), for one example, when the user selects MyEntertainment 204 by rotating polyhedron 217 such that the corresponding face is in the foreground, the visual text “MyEntertainment” can be highlighted and the corresponding polygonal face can be highlighted, e.g., with color, to indicate it is in the foreground and selected by a user. Alternatively, a driver or user can select MyEntertainment 204 by using a control object such as a cursor or avatar object. For one example, the visual text for MyActivities 205 and MyHealth 203, which are not selected by the driver or user, can be shown differently than MyEntertainment 204. For example, the text for “MyActivities” and “MyHealth” can be blurred when not selected and the corresponding polygonal faces of rotating polyhedron 217 are shaded or un-highlighted differently than MyEntertainment 204. For one example, un-used faces 201 of rotating polyhedron 217 can also be blurred to indicate the faces including lines or dots (junction where lines meet) do not represent faces with parameters or user information. The blurriness of un-used faces 201 can also be used to show depth of rotating polyhedron 217.

For one example, faces of rotating polyhedron 217 can also change color or blink to indicate new information or information or parameters generated related to, e.g., MyEntertainment 204, MyActivities 205, and MyHealth 206. A red color, e.g., for MyActivities 205, can indicate a new scheduled meeting request. For other examples, environment 100 can learn what is interesting to a driver or user and make recommendations as to activities by using a suggestion engine, e.g., as shown in display area 3 (208)—“Suggested by Byton.” For example, MyActivities 204 can include data points indicating car washes. By tracking this information, environment 100 can suggest to a user when to have a car wash and where is the nearest car wash.

Exemplary Data Processing and Computing System Architecture

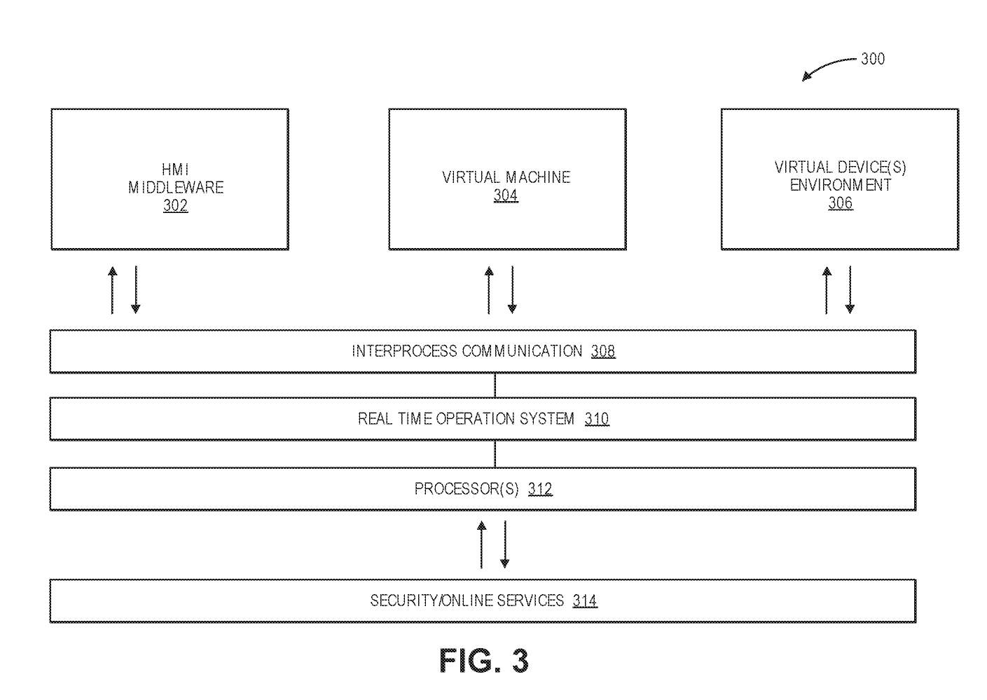

FIG. 3 illustrates one example block diagram of data processing system architecture 300 for the exemplary environment 100 of FIG. 1. For one example, data processing system architecture 300 can represent a computing system for driver tablet 110 or a computing system within automobile dashboard 137 of FIG. 1. Data processing system architecture 300 includes processor(s) 312, real time operation system 310, and inter-process communication 308 coupled with HMI middleware 302, virtual machine 304, virtual devices(s) environment 306, and secure/online services 314. Processor(s) 312 can include any type of ARM®, nVidia®, or Intel® microprocessor or central processing unit (CPU) configured to perform techniques and operations disclosed herein. For one example, processor(s) 312 can include a system-on-a-chip (SOC) such as nVidia Tegra® providing a graphical processing unit (GPU) architecture which can be used in automobiles and provide three-dimensional (3D) rendering for generating and displaying rotating polyhedron 117 or 217. Processor(s) 312 can also include nVidia Drive CX hardware and software solutions providing advanced graphics and computer vision navigation for coast-to-coast display 102, 202 configured to implement techniques and operations disclosed herein. Processor(s) 312 can also include Intel In-Vehicle Infotainment (IVI)® or nVidia Drive CX® processing architecture and software providing information and entertainment features for automobiles configured using techniques and operations disclosed herein.

For one example, real-time operating system 310 can be a Unix® based operating system which can provide cloud connection via security/online services 314 and virtual device communication via virtual device(s) environment 306. Security/online services 314 can include a smart antenna and provide a secure gateway to external cloud services requiring user authentication using high speed wireless communication such as Long-Term Evolution (LTE) standard. Bluetooth® communication can also be provided by security/online services 314 for data processing system architecture 300. Virtual devices(s) environment 306 can include, e.g., Android® based environment of devices and virtual machines which can communicate with data processing system architecture 300.

Human machine interface (HMI) middleware 302 can include software to provide graphical user interfaces and controls or a driver or user of environment 100 and driver tablet 110 or a computing system (or computer) within dashboard 137. For one example, HMI middleware 302 can include the Unity® or Softkinetics® software configured for providing user interfaces and controls to coast-to-coast displays 102, 202 and rotating polyhedrons 117, 217 of FIGS. 1-2 based on techniques and operations disclosed herein. For one example, virtual machine 304 can operate as driver tablet 110 or an automobile computer or user interface applications or controls for coast-to-coast display 302 using HMI middleware 302 such as Unity® or Softkinetics® software and inter-process communication 308. HMI middleware 302 can also include software to recognize user gestures from captured by gesture control/user identification 127. Examples of gesture capturing software includes Intel Realsense® software and hardware configured to recognize hand gestures to control interfaces on coast-to-coast display 102, 202.

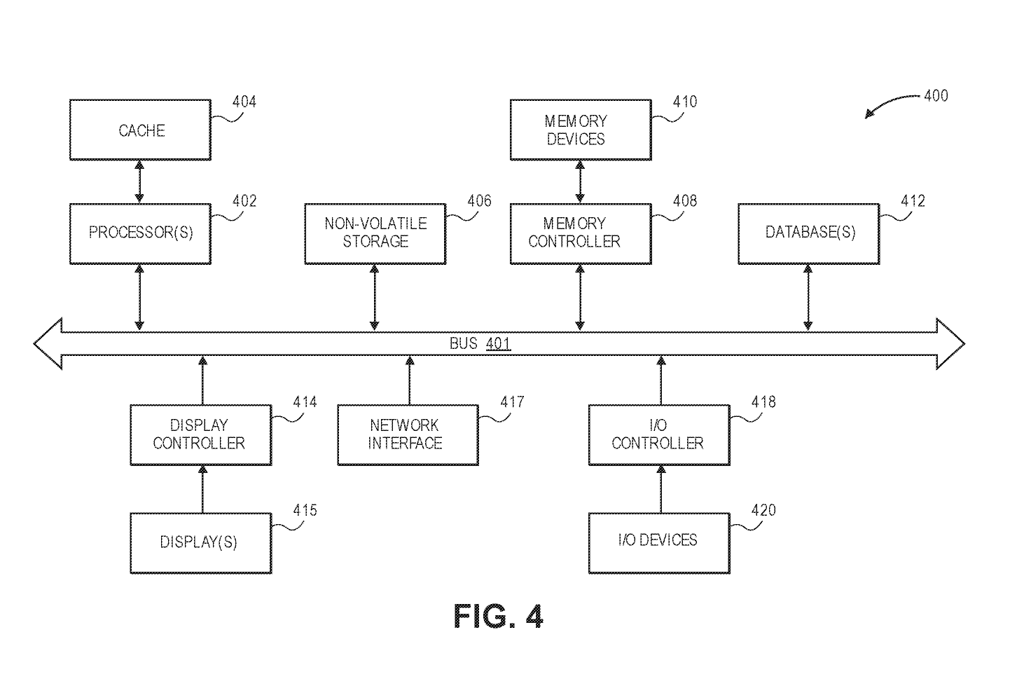

FIG. 4 illustrates one example block diagram of a computing system 400 for the data processing system architecture 300 of FIG. 3. For example, computing system 400 can represent the various components used for driver tablet 110 or other computers used in environment 100 or 200 of FIGS. 1-2. Although FIG. 4 illustrates various components of a data processing or computing system, the components are not intended to represent any particular architecture or manner of interconnecting the components, as such details are not germane to the disclosed examples or embodiments. Network computers and other data processing systems or other consumer electronic devices, which have fewer components or perhaps more components, may also be used with the disclosed examples and embodiments.

Referring to FIG. 4, computing system 400, which is a form of a data processing or computing system, includes a bus 203, which is coupled to processor(s) 402 coupled to cache 404, display controller 414 coupled to a display 415, network interface 417, non-volatile storage 406, memory controller coupled to memory 410, I/O controller 418 coupled to I/O devices 420, and database 412. Processor(s) 402 can include one or more central processing units (CPUs), graphical processing units (GPUs), a specialized processor or any combination thereof. Processor(s) 402 can retrieve instructions from any of the memories including non-volatile storage 406, memory 410, or database 412, and execute the instructions to perform operations described in the disclosed examples and embodiments.

Examples of I/O devices 420 include mice, keyboards, printers and other like devices controlled by I/O controller 418. Network interface 417 can include modems, wired and wireless transceivers and communicate using any type of networking protocol including wired or wireless WAN and LAN protocols including LTE and Bluetooth standards. Memory 410 can be any type of memory including random access memory (RAM), dynamic random-access memory (DRAM), which requires power continually in order to refresh or maintain the data in the memory. Non-volatile storage 406 can be a mass storage device including a magnetic hard drive or a magnetic optical drive or an optical drive or a digital video disc (DVD) RAM or a flash memory or other types of memory systems, which maintain data (e.g. large amounts of data) even after power is removed from the system.

Memory devices 410 or Database 412 can be used by tablet 110 and processors 402 to store user information and parameters. For example, memory devices 410 or database 412 can store user information or parameters related to, e.g., MyHealth, MyActivities, or MyEntertainment types of user information. Although memory devices 410 and database 412 are shown coupled to system bus 201, processor(s) 402 can be coupled to any number of external memory devices or databases locally or remotely by way of network interface 417. For one example, processor(s) 402 can implement techniques and operations described in FIGS. 1-10 for using a rotating polyhedron 117 or 217 having a plurality of faces defined by dots and lines using display controller 415 and display(s) 415. Display 415 can represent coast-to-coast-displays 102, 202 in FIGS. 1-2.

Examples and embodiments disclosed herein can be embodied in a data processing system architecture, data processing system or computing system, or a computer-readable medium or computer program product. Aspects, features, and details of the disclosed examples and embodiments can take the hardware or software or a combination of both, which can be referred to as a system or engine. The disclosed examples and embodiments can also be embodied in the form of a computer program product including one or more computer readable mediums having computer readable code which can be executed by one or more processors (e.g., processor(s) 402) to implement the techniques and operations disclosed in FIGS. 1-10.

Exemplary Rotating Three-Dimensional Objects and Polyhedrons

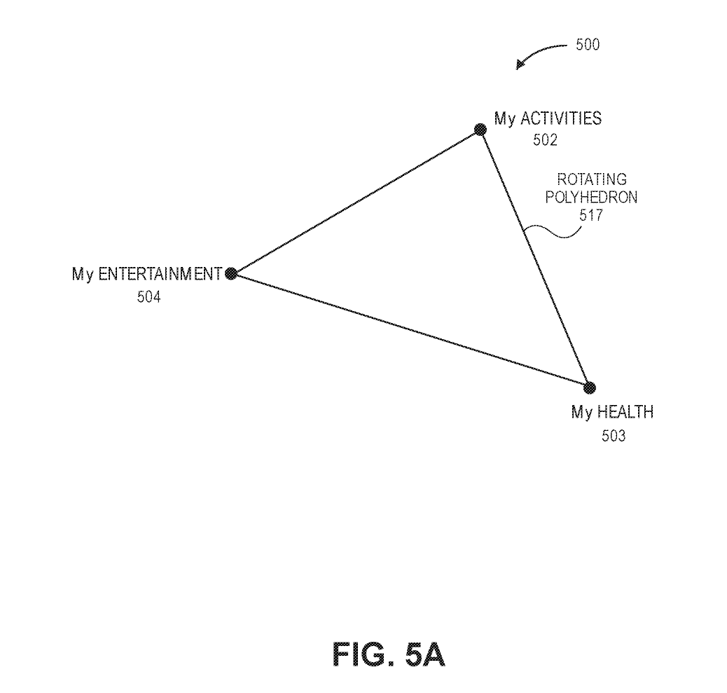

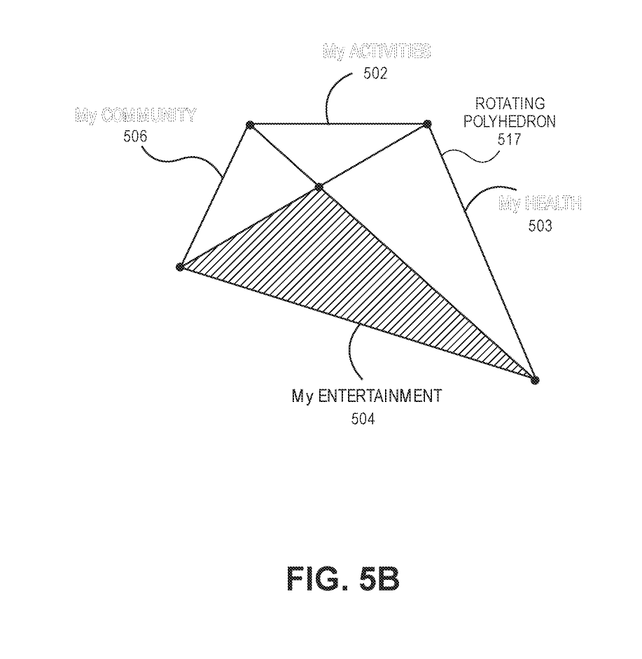

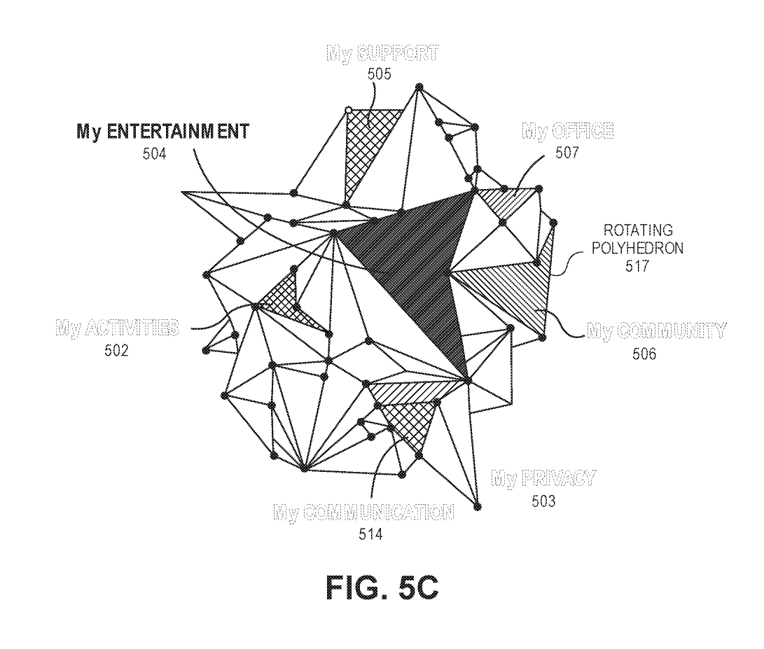

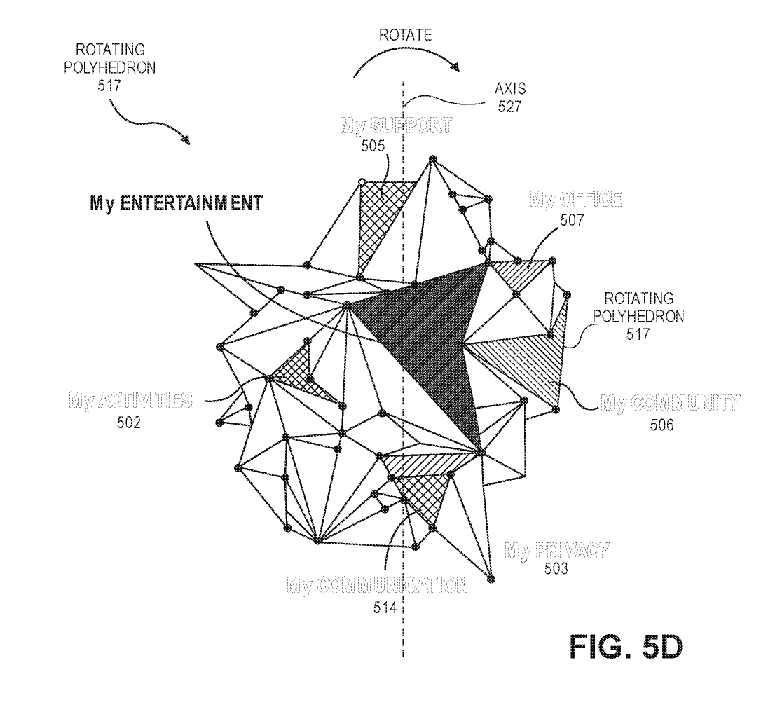

FIG. 5A-5D illustrate examples of generating rotating polyhedrons providing types of user information. Referring to FIG. 5A, an initial face or set of data points 500 is shown for generating rotating polyhedron 517 starting with an initial shape. For this example, the initial shape includes three dots and lines representing a basic triangle. Other shapes can be used and not limited to triangles. Polyhedron 517 includes points or dots where lines meet representing types of user information such as MyActivities 502, MyHealth 503, and MyEntertainment 504.

Referring to FIG. 5B, as additional categories, information, or parameters are created, rotating polyhedron 517 can morph into different shapes and objects including an additional user information category MyCommunity 506. For one example, polyhedron 517 starts with a basic triangle having a single face with three dots and can morph into a multi-faceted rotating polyhedron 517 as user categories, information, or parameters are generated or updated or added.

For one example, in generating polyhedron 517, the shape of the initial mesh or wireframe can become distorted as new dots and lines are generated based on generated or updated user information. Polyhedron 517 can morph into various meshes or wireframes randomly using any type of random generator or noise modifier to distort the mesh or wireframe defining polyhedron 517 to provide a depth of field for polyhedron 517 when shown on coast-to-coast display 102, 202. For one example, HMI middleware 302 can include a plug-in that can perform distortion and depth of field generation for rotating polyhedrons such as polyhedrons 117, 217, and 517 in real-time as user information is generated, updated, or added.

For one example, MyEntertainment 504 is highlighted to indicate that it is type of user information selected by a user and highlighted on a coast-to-coast display 102, 202. MyCommunity 506, MyActivities 502, and MyHealth 503 can be blurred to indicate that are types of user information not selected by a user. The faces for MyCommunity 506, MyActivities 502, and MyHealth 503 can also be un-highlighted to indicate they are not selected by a user. Each of the types of information for rotating polyhedron 517 have three dots and lines for MyCommunity 506, MyActivities 502, MyHealth 503, and MyEntertainment 504. Each point in rotating polyhedron 517 can indicate user information or parameter, e.g., a scheduled event for MyActivities 502 or a movie for MyEntertainment 504.

For other examples, information or parameters associated with each dot can visually affect properties such as opacity of lines connecting dots, distance of the lines and lines, color or shade of the lines and faces of rotating polyhedron 517. For example, the dot at the right point of the face for MyEntertainment 504 on rotating polyhedron 517 can represent a movie that was last seen later than the movies represented by the dots on the left side of the face for MyEntertainment 504 which are closer together indicating that those moves were seen most recently. For example, the two dots on the left of MyActivities 502 can represent two scheduled meetings that are upcoming and the dot to the right can represent a scheduled meeting later in time than the two upcoming meetings. That is, dots closer together can represent meetings sooner in time.

Referring to FIG. 5C, as a driver or user populates categories of user information over time, rotating polyhedron 517 can morph into multi-faceted three-dimensional objects as shown having a plurality of faces corresponding to different types of user information. Examples of types of information shown in FIG. 5C include MyActivities 502, MyPrivacy 503, MyEntertainment 504, MySupport 505, MyCommunity 506, MyOffice 507, and MyCommunication 514. For one example, MyEntertainment 504 can be highlighted or have a different color than the other types of information in which a user can select it by rotating polyhedron 517 such that MyEntertainment 504 is in the foreground. For one example, the non-selected types of information can have its text blurred for MyActivities 502, MyPrivacy 503, MySupport 505, MyOffice 507, MyCommunity 506, and MyCommunication 514. For other examples, the faces including its dots and lines not corresponding with a type of user information can also be blurred or faded out.

MyActivities 502 can include user information and applications related to, e.g., shopping, planning events dates, suggestions based on location of the automobile. MyPrivacy 503 can include options and controls to have certain or private information locked or masked or disconnected from coast-to-coast display 102, 202, e.g., disconnecting or hiding user information and applications. MyEntertainment 504 can include user information and applications related to, e.g., music, audiobooks, movies, games, news, etc. MySupport 505 can include user information and applications related to, e.g., concierge services, online payments and services, smart home connections, delivery drop-box, etc. MyCommunity 506 can include user information and applications related to, e.g., user contacts and phone numbers, emails addresses, etc. MyOffice 507 can include user information and applications related to, e.g., office programs, integration of video conferencing, application support for meetings in automobile, etc. MyCommunication 514 can include user information and applications related to, phone calls, text messages, emails, etc.

Referring to FIG. 5D, rotating polyhedron 517 is shown how it can rotate along axis 527, e.g., from a user gesture such as user hand 107 in FIG. 1 providing a gesture indicating left to right rotation. Likewise, rotating polyhedron 517 can rotate from right to left based on gestures of user hand 107 indicating a swipe from right to left. For one example, rotating polyhedron 517 can rotate in free space on coast-to-coast display 102, 202 at a desired speed or increased speed from a hand gesture. Axis 577 is shown as a longitudinal axis, but can also be horizontal and rotating polyhedron 517 can rotate from top to bottom or bottom to top based on user gestures. Axis 577 can also be slanted or at an angle less or greater than 90 degrees and rotate accordingly based on user gestures. Based rotating of polyhedron 517, one or more faces of rotating polyhedron 517 can be moved to the foreground and highlighted or have a different color to indicate selection by a driver or user.

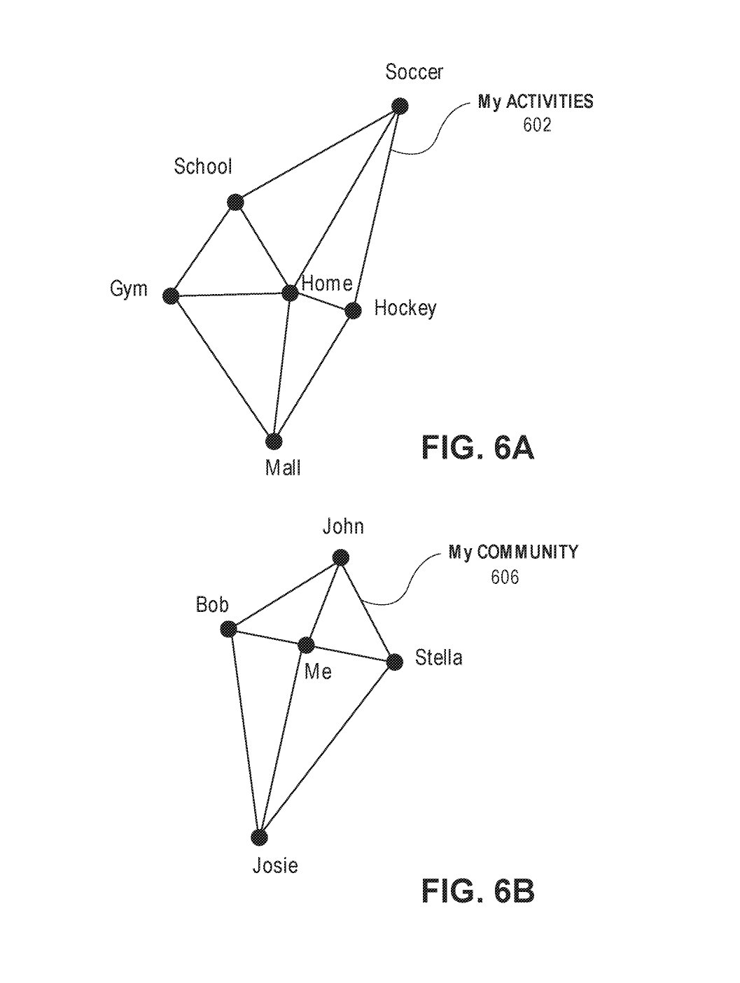

FIG. 6A-6B illustrates exemplary faces for rotating polyhedron. For one example, dots represent a fact of a rotating polyhedron can be weighted based on relationships of the dots to respective user information and parameters. For example, referring to FIG. 6A, a face for MyActivities 602 can include locations traveling to and from Home such as School, Soccer, Hockey, Mall, and Gym. For one example, dots closest to Home can be weighted to indicate a location closer in distance to Home. For example, if Hockey is closest to Home among other locations, it can be weighted such that its dot is drawn and closest to Home in contrast to other locations farther away from Home. For example, if Soccer is farthest away from Home, its dot can be weighted such that it is drawn farther away in MyActivities 602 which can represent a face on a rotating polyhedron.

Referring to FIG. 6B, a face for MyCommunity 606 can include Me, John, Stella, Josie, and Bob each having a dot on the face of MyCommunity 606. The dots can be weighted such that those individuals closest to Me, e.g., family members, would be drawn closer to Me in MyCommunity 606. For example, Bob, John, and Stells can be brothers and sister to Me, and Josie can be a school friend to Me whose dot is farther away from Me. On a rotating polyhedron, referring to FIGS. 6A-6B, if a face for MyActivities 602 or MyCommunity is moved to the foreground of the display and selected by a driver or user, the faces of the polyhedron can expand on coast-to-coast display 102, 202 to show the dots and corresponding to locations or names as shown FIGS. 6A-6B.

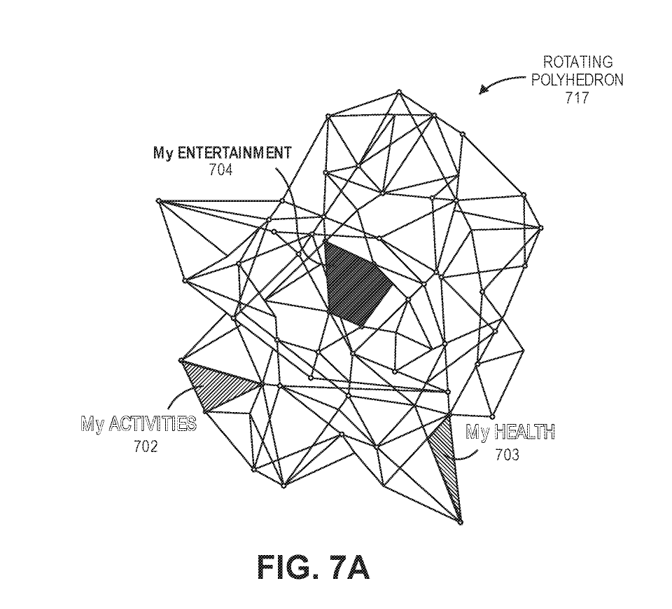

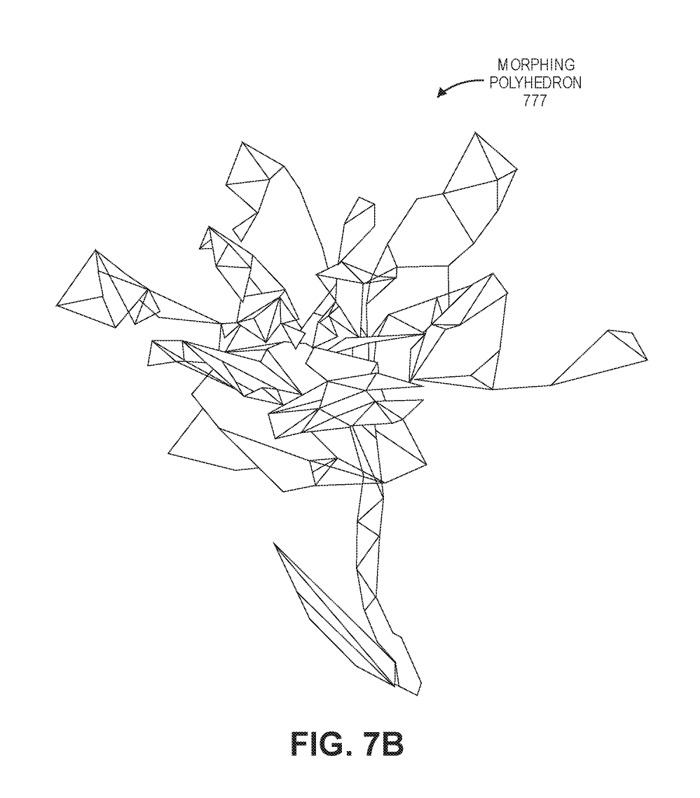

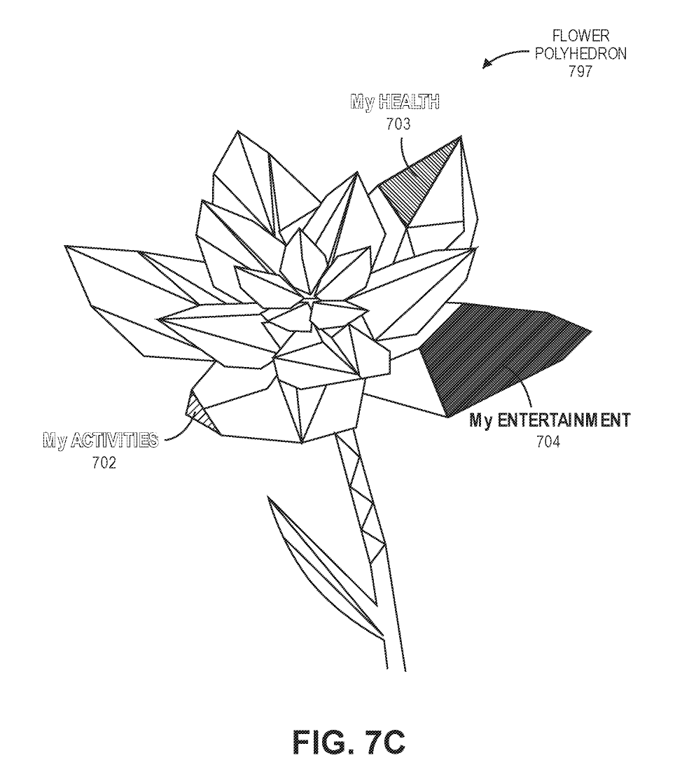

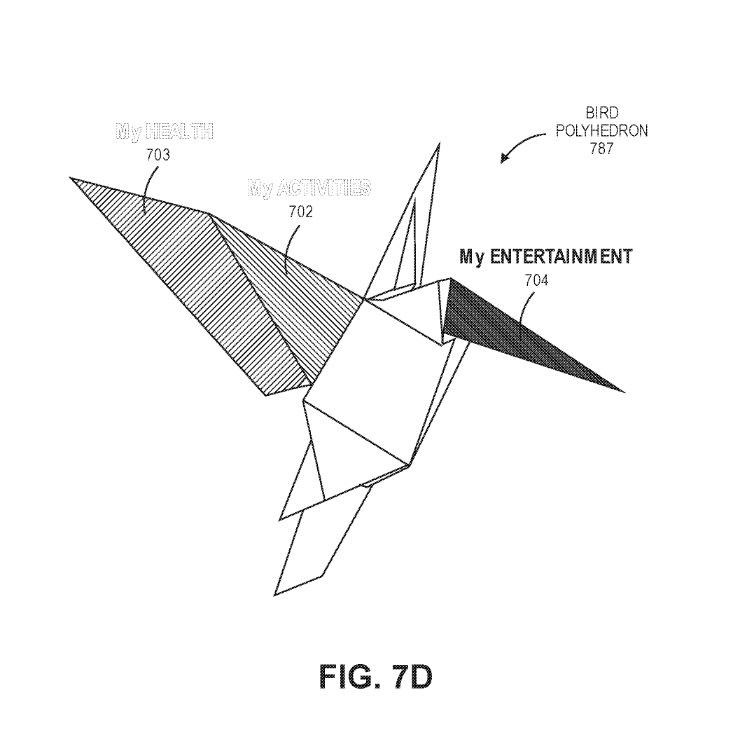

FIGS. 7A-7D illustrate examples of different types of three-dimensional objects for rotating polyhedrons. FIG. 7A illustrates one example of a rotating polyhedron 717 having a plurality faces including MyEntertainment 704, MyHealth 703, and MyActivities 702. Referring to FIG. 7A, MyEntertainment 704 is in the foreground and selected by a driver or user and can be highlighted as shown, e.g., highlighted in color on coast-to-coast display 102, 202. The text for MyActivities 702 and MyHealth 703 can be blurred to indicate that they are not selected by the user. For one example, a driver or user may want a different type of three-dimensional object to access user information or applications on coast-to-coast display 101, 102.

Referring to FIG. 7B, morphing polyhedron 777 is shown to illustrate that rotating polyhedron 717 in FIG. 7A is morphing into a desired or selected three-dimensional object. For one example, referring to FIG. 7C, morphing polyhedron 777 can morph into a three-dimensional flower object such as flower polyhedron 797. Flower polyhedron 797 includes faces for MyEntertainment 704, which is highlighted indicating it is selected and in the foreground, and MyHealth 703 and MyActivities 702 with blurred text to indicate they are not selected. Flower polyhedron 797 can rotate in a clockwise or counter-clock wise matter or along any number of longitudinal axes. Flower polyhedron 797 can also be a decorative object for display on coast-to-coast display 101, 102 no used for accessing user information or applications. Referring to FIG. 7D, morphing polyhedron 777 can morph into other objects such as bird polyhedron 787 depicting a bird. Bird polyhedron 787 includes faces for MyEntertainment 704, which is highlighted indicating it is selected and in the foreground, and MyHealth 703 and MyActivities 702 with blurred text to indicate they are not selected. Bird Polyhedron 787 can also be used for decorative purposes within coast-to-coast display 102, 202. For one example, a driver or user of exemplary environment 100 can select the type of three-dimensional object (e.g., flower polyhedron 797 or bird polyhedron 787) that can be used as a rotating polyhedron instead of randomly generating a mesh or wireframe for a rotating polyhedron.

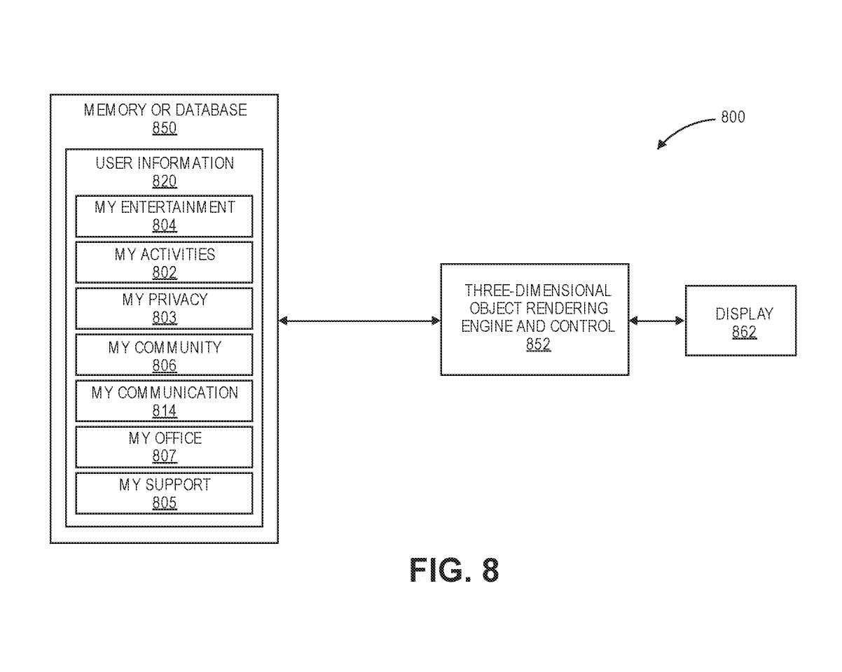

FIG. 8 illustrates a block diagram of a computing system 800 to render a three-dimensional object on a display. Computing system 800 includes a memory or database 850 coupled to three-dimensional rendering engine 852 that can display a rotating polyhedron on display 862. Memory or database 850 includes user information 820. For one example, user information 820 can include a plurality of types of user information stored in memory or database 850. Examples of types of user information 820 which can be stored in memory or database 850 can include MyEntertainment 804, MyActivities 802, MyHealth 803, MyCommunity 806, MyCommunication 814, MyOffice 807, and MySupport 805. Information or parameters associated with user information 820 can be generated or received, e.g., by a user of driver tablet 110, smart watch 113, or mobile phone 133, e.g., as shown in FIG. 1.

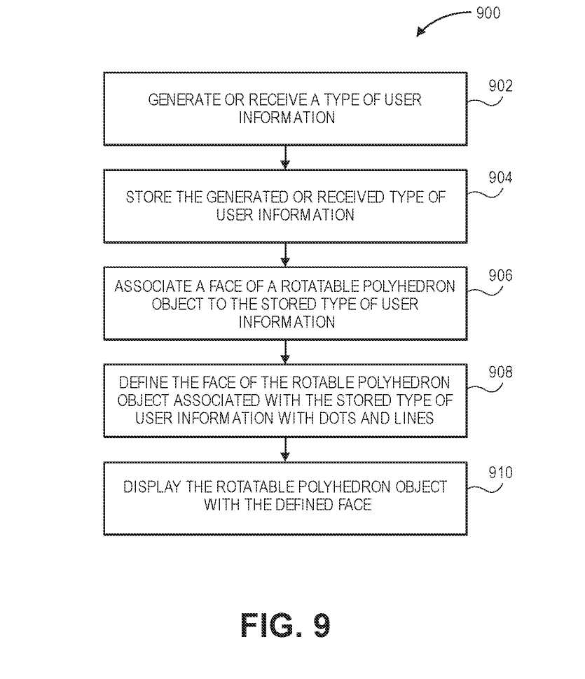

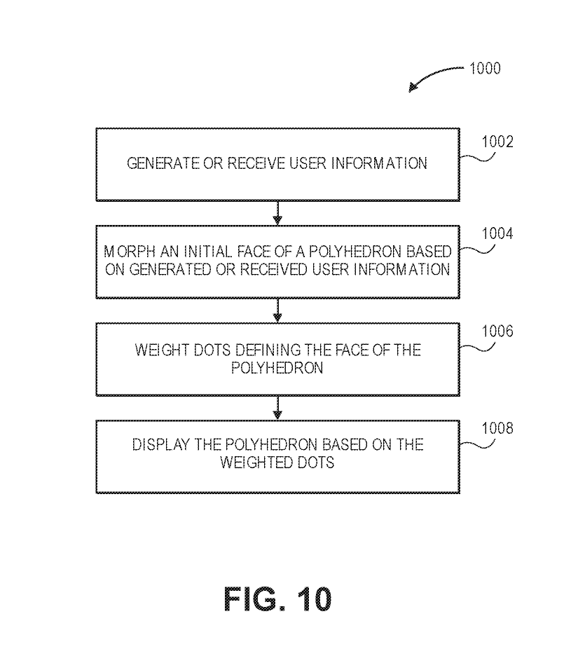

Three-dimensional object rendering engine and control 852 (engine 852) can process user information and render a rotating polyhedron as shown in FIGS. 1-2 and 5A-7D using operations disclosed in FIGS. 9-10. For each of the types of information, engine 852 can highlight or un-highlight faces of the rotating polyhedron (e.g., rotating polyhedron 117, 217, 517, 717, 777, 787) corresponding to different types of information. Engine 852 can also distort, blur, or change objects for a rotatable polyhedron to be shown on coast-to-coast display 101, 102 as described in FIGS. 1-2 and 5A-7D.

FIG. 9 illustrates a flow diagram of one example of an operation 900 to display a rotating polyhedron with faces corresponding to types of user information. At block 902, types of user information are generated or received (e.g., MyEntertainment, MyActivities, and MyHealth). At block 904, the types of user information are stored. For example, user information 820 can be stored in memory or database 850 shown in FIG. 8. At block 906, a face of a rotating polyhedron is associated to a type of user information. For example, engine 852 can associate any of the user information 820 with a face of a rotating polyhedron (e.g., polyhedron 117, 127, 517, 717, 777, 787). At block 908, a face of the rotating polyhedron is defined with dots and lines corresponding to a type of user information. For example, engine 852 can generate a mesh or wireframe for a rotating polyhedron (e.g., polyhedron 117, 127, 517, 717). At block 910, the rotating polyhedron is displayed, e.g., on coast-to-coast display 102, 202.

FIG. 10 illustrates a flow diagram of one example of an operation 1000 to display a rotating polyhedron with weighted dots. At block 1002, an initial face of a polyhedron is used to start building or generating a rotating polyhedron. For example, referring to FIG. 5A, an initial face 500 can include a triangle with points for MyEntertainment 504, MyActivities 502, and MyHealth 503. At block 1004, dots and lines are added for each type of user information generated or received. For example, engine 852 can generate dots and lines to define mesh or wireframe for a rotating polyhedron (e.g., polyhedron 517). At block 1006, the dots are weighted. For example, engine 852 can weight dots as described in FIGS. 6A-6B for a face of a polyhedron (e.g., MyActivities 602, MyCommunity 606). At block 1008, a rotating polyhedron (e.g., 117, 217, 517, 717) is displayed based on the weighted dots, e.g., as shown in FIGS. 6A-6B.

In the foregoing specification, the invention has been described with reference to specific exemplary embodiments thereof. It will, however, be evident that various modifications and changes may be made thereto without departing from the broader spirit and scope of disclosed examples and embodiments. The specification and drawings are, accordingly, to be regarded in an illustrative rather than a restrictive sense.

What is claimed is:

1. A data processing system comprising:
a display;
a memory storing one or more types of information related to a user; and
a processor coupled to the display and memory, wherein the processor is configured to generate a rotatable three-dimensional object visually representing one or more types of user information on the display.

2. The data processing system of claim 1, wherein the rotatable three-dimensional object is a polyhedron including a plurality of faces wherein each type of user information corresponds to a face of the polyhedron.

3. The data processing system of claim 2, wherein each face that corresponds to a type of user information includes a plurality of dots connected by lines defining the face.

4. The data processing system of claim 3, wherein each dot of each face that corresponds to a type of user information represents a data point or a parameter of the corresponding type of user information.

5. The data processing system of claim 4, wherein each dot of each face that corresponds to a type of user information can be weighted that distorts the polyhedron.

6. The data processing system of claim 5, wherein the polyhedron is randomly distorted based on the weight for each dot.

7. The data processing system of claim 2, wherein the processor is further configured to distort the polyhedron if data points or parameters are updated or changed for each type of user information.

8. The data processing system of claim 7, further comprising:
a hand movement capturing device coupled to the processor to capture hand gestures of the user, wherein the processor is further configured to rotate the polyhedron on the display based on the captured hand gestures of the user.

9. The data processing system of claim 8, wherein the processor is further configured to select one of the faces of the polyhedron that corresponds to a type of user information based on the captured hand gestures.

10. The data processing system of claim 9, wherein the types of information include at least entertainment, health, or activity type of user information.

11. The data processing system of claim 8, wherein the processor is further configured to generate a control object on the display corresponding to the captured hand gestures to select one of the faces of the polyhedron that corresponds to a type of user information.

12. The data processing system of claim 1, wherein the display is a coast-to-coast display for an electric or non-electric vehicle.

13. The data processing system of claim 12, wherein the coast-to-coast display includes a plurality of display areas and the rotatable three-dimensional object is displayed in at least one of the display areas.

14. A computer-implemented method comprising:
generating or receiving a type of user information;
storing the generated or received type of user information;
associating a face of a rotatable polyhedron object with the stored type of user information;
defining the face of the rotatable polyhedron object associated with the stored type of user information with dots and lines; and
displaying the rotatable polyhedron object with the defined face.

15. The computer-implemented method of claim 14, wherein storing the generated or received type of user information includes storing the type of user information in a database.

16. The computer-implemented method of claim 14, further comprising selecting the defined the face of the displayed rotatable polyhedron object associated with the stored type of user information with dots and lines; and

17. A computer-implemented method comprising:
generating or receiving user information;
morphing an initial face of a polyhedron based on the generated or received user information;
weight dots defining one or more faces of the polyhedron; and
displaying the polyhedron based on the weighted dots.

18. The computer-implemented method of claim 17, further comprising selecting one more faces of the displayed polyhedron defined by the weighted dots.

19. A non-transitory machine-readable medium, including instructions, which if executed by a computing system, cause the computing system to:
generate or receive a type of user information;
store the generated or received type of user information;
associate a face of a rotatable polyhedron object with the stored type of user information;
define the face of the rotatable polyhedron object associated with the stored type of user information with dots and lines; and
display the rotatable polyhedron object with the defined face.

20. The non-transitory machine-readable medium of claim 19, including instructions, which if executed by the computer system, cause the computing system to select the face associated with the stored type of user information by user gestures.

21. A non-transitory machine-readable medium, including instructions, which if executed by a computing system, cause the computing system to:
generate or receive user information;
morph an initial face of a polyhedron based on the generated or received user information;
weight dots defining one or more faces of the polyhedron; and
display the polyhedron based on the weighted dots.

22. The non-transitory machine-readable medium of claim 21, including instructions, which if executed by the computer system, cause the computing system to select one or more faces of the polyhedron providing generated or received user information.
